(19) United States
(12) Patent Application Publication
(10) Pub. No.: US 2023/0167333 A1
(43) Pub. Date: Jun. 1, 2023

(54) COATED CELLULAR GLASS INSULATION SYSTEM

(71) Applicant: Owens Corning Intellectual Capital, LLC, Toledo, OH (US)

(72) Inventors: Helen Huang, New Albany, OH (US); Marc Clynhens, Linden (BE); Steven Badger, Pittsburgh, PA (US)

(21) Appl. No.: 18/070,727

(22) Filed: Nov. 29, 2022

Related U.S. Application Data
(60) Provisional application No. 63/283,620, filed on Nov. 29, 2021.

(51) Int. Cl. C09D 183/04; B32B 5/32; B32B 5/18

(52) U.S. Cl. CPC C09D 183/04; B32B 5/32; B32B 5/18; B32B 2266/057; B32B 27/065

(57) ABSTRACT

A cellular glass insulation system for insulating a fluid/liquid storage vessel at elevated temperature, is disclosed. The system is comprised of segments of cellular glass insulation. A sealant is provided on at least one liquid-facing surface of the segments of cellular glass insulation to seal the segments from moisture, including when completely submerged.

### CROSS-REFERENCE TO RELATED APPLICATIONS

This application claims priority to and the benefit of U.S. Provisional Patent Application No. 63/283,620, filed Nov. 29, 2021, the entire disclosure of which is incorporated herein by reference in full.

### FIELD

The present invention relates to insulation systems for use in high heat and humidity conditions, and more particularly, to systems that avoid the problems associated with conventional heated vessel insulation applications using cellular glass insulation.

### BACKGROUND

Cellular glass is a preferred choice for many insulation applications due to its ability to maintain its shape under strenuous conditions including both high and low temperatures as well as its closed-cell makeup, making it impermeable to vapor. Due to its rigid structure, cellular glass is often fabricated into sections for insulating industrial and commercial vessels. These sections are then assembled around the volume to be insulated. Thereby, the cellular glass provides thermal insulation to the materials contained within the vessel.

One area that poses issues for cellular glass is immersion in water. Specifically, cellular glass is known to degrade over time when immersed or otherwise exposed to water at elevated temperatures. Conventional coatings that are used in conjunction with cellular glass (e.g., gypsum cements) are generally ineffective at preventing moisture intrusion and the resulting cellular glass degradation.

### SUMMARY

The general inventive concepts are based, in part, on the recognition that conventional, cellular glass sealants have proven ineffective at sealing against water at elevated temperatures. A need exists for a cellular glass sealant/protectant coating that can 1) bind effectively to the cellular glass surface, 2) prevent moisture intrusion under elevated temperature when submerged and 3) survive for extended periods of time in harsh environments (to prevent the need for removal and reapplication). Applicants have discovered that certain silicone-based rubber sealants can deliver such properties. In certain exemplary aspects, a system for insulating a vessel according to the general inventive concepts is suitable for insulation of vessels to a temperature of 60° C. or more, including temperatures of 90° C. or more. The system can provide insulation when fully or partially submerged for a period of at least three years, including at least four years, and including at least five years.

In certain exemplary aspects, the general inventive concepts contemplate a cellular glass insulation system for insulating a liquid-containment vessel, wherein the liquid is at an elevated temperature (e.g., above about 60° C. to about 90° C. The system comprises a plurality of cellular glass insulation segments and a silicone coating of a suitable thickness (e.g., about 0.5 mm-2 mm) on at least one liquid-facing surface of each of the cellular glass insulation segments.

The general inventive concepts further contemplate a method of insulating a liquid containment vessel comprising a liquid at an elevated temperature. The method comprises applying a silicone sealant to each liquid-facing surface of a plurality of cellular glass insulation segments and positioning the cellular glass insulation segments in a liquid storage vessel (e.g., a tank or pit), wherein the liquid is water having a temperature of at least 90° C. In certain embodiments, at least one cellular glass insulation segment is at least partially submerged in the water.

Yet further aspects of the general inventive concepts contemplate a cellular glass insulation system for insulating a liquid, wherein the liquid is at an elevated temperature (e.g., above about 60° C., to about 90° C.). The system comprises one or more coated cellular glass insulation segments positioned at or near the surface of the liquid. In certain embodiments, the coated cellular glass insulation segments comprise a silicone coating of a suitable thickness (e.g., about 0.5 mm-2 mm) on at least one liquid-facing surface of each cellular glass insulation segment. The cellular glass insulation system may comprise a plurality of coated cellular glass insulation segments arranged in a layer floating on the liquid. In certain embodiments, the cellular glass insulation system comprises multiple layers of cellular glass insulation segments positioned on the liquid.

Other aspects and features of the general inventive concepts will become more readily apparent to those of ordinary skill in the art upon review of the following description of various exemplary embodiments in conjunction with the accompanying figures.

### BRIEF DESCRIPTION OF THE DRAWINGS

The general inventive concepts, as well as embodiments and advantages thereof, are described below in greater detail, by way of example, with reference to the drawings in which:

FIG. 1 is an image of a cellular glass insulation segment coated with a hot melt sealant, after prolonged submersion in heated water.

FIG. 2 is an image of a cellular glass insulation segment coated with a wax-modified gypsum sealant, after prolonged submersion in heated water.

FIG. 3 is an image of a cellular glass insulation segment coated with a polyurethane sealant, after prolonged submersion in heated water.

FIG. 4 is an image of a cellular glass insulation segment coated with a hybrid polymer sealant, after prolonged submersion in heated water.

FIG. 5 is an image of a cellular glass insulation segment coated with a silicone sealant, after prolonged submersion in heated water. This sample was determined to have allowed water penetration.

FIG. 6 is an image of a cellular glass insulation segment coated with an alkoxy-cure silicone sealant. The sample showed good qualitative immersion results but was determined to have allowed water to penetrate.

FIG. 7 is an image of a cellular glass insulation segment coated with an alkoxy-cure silicone sealant after immersion testing.

FIG. 8 is an image of a cellular glass insulation segment coated with an acetoxy-cure silicone sealant after immersion in a heated bath for weeks.

FIG. 9 is an image of the cellular glass insulation segment of FIG. 8 with the acetoxy-cure silicone sealant being partially removed after immersion testing.

FIG. 10 is an SEM image of a silicone sealant according to the general inventive concepts.

FIG. 11 is an SEM image of a silicone sealant, showing voids and filler particles in the matrix.

FIG. 12 is an SEM image of a silicone sealant, showing voids and filler particles in the matrix.

FIG. 13 is a picture of a cellular glass slab coated with a polyurethane sealant prior to immersion in a heated water bath.

FIG. 14 is a picture of a cellular glass slab coated with a polyurethane sealant after immersion in a heated water bath.

FIG. 15 is a picture of an exemplary heated water retention vessel.

FIG. 16 is a drawing of an insulated vessel according to the general inventive concepts.

### DETAILED DESCRIPTION

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

While various exemplary embodiments are described or suggested herein, other exemplary embodiments utilizing a variety of methods and materials similar or equivalent to those described or suggested herein are encompassed by the general inventive concepts.

Unless defined otherwise, all technical and scientific terms used herein have the same meaning as commonly understood by one of ordinary skill in the art to which the invention belongs. In this connection, unless otherwise indicated, concentrations of ingredients given in this document refer to the concentrations of these ingredients in the master batch or concentrate, in keeping with customary practice.

The general inventive concepts relate to systems for and methods of insulating a liquid containment vessel or similar structure, including insulating a heated liquid within the liquid containment vessel, using cellular glass. While the discussion presented herein is focused on insulation, those of ordinary skill in the art will recognize the applicability of the cellular glass insulation systems described herein is not limited to the specific embodiments discussed herein.

In certain exemplary aspects, the general inventive concepts contemplate a cellular glass insulation system for thermally insulating a liquid containment vessel/reservoir, wherein the liquid is at an elevated temperature (e.g., above 60° C.). In certain exemplary aspects, the system comprises a plurality of cellular glass insulation segments, wherein each of the cellular glass insulation segments comprises a liquid facing surface, a surface opposing the liquid facing surface, and a plurality of side surfaces extending between the opposing surfaces; and a sealant applied on at least a portion of the liquid facing surface of the cellular glass insulation segments. In certain exemplary embodiments, the cellular glass insulation system comprises a cover positioned above the top of the liquid in the liquid containment vessel.

The general inventive concepts further contemplate a method of insulating a liquid containment vessel. The method comprises applying a silicone sealant to at least at least a portion of the liquid-facing surface of a plurality of cellular glass insulation segments and positioning the cellular glass insulation segments on or at least partially within the liquid in a liquid storage vessel. The liquid may comprise, for example, water that is heated to an elevated temperature, e.g., a temperature of at least 60° C. (e.g., 60 to 90° C., or greater), including at least 70° C., including at least 80° C., including at least 90° C., or more. The cellular glass insulation segments may define the exterior of the liquid storage vessel (i.e., one or more of the segments may be positioned directly on the liquid in the vessel). In certain embodiments, at least one cellular glass insulation segment is submerged in the water and may be partially or entirely submerged in the water.

The general inventive concepts further contemplate a cellular glass insulation system for insulating a liquid, wherein the liquid is at an elevated temperature (e.g., above about 60° C., to about 90° C.). The system comprises one or more coated cellular glass insulation segments positioned at or near the surface of the liquid. The coated cellular glass insulation segments may comprise a silicone coating of a suitable thickness (e.g., about 0.5 mm-2 mm) on at least one liquid-facing surface of each of the cellular glass insulation segments. In certain embodiments, the cellular glass insulation system comprises a plurality of coated cellular glass insulation segments arranged in a layer floating on a surface of the liquid. In certain embodiments, the cellular glass insulation system comprises 2 or more layers of cellular glass insulation segments positioned on the liquid. In certain embodiments, at least one cellular glass insulation segment is submerged in the water and may be partially or entirely submerged in the water.

Cellular glass is a non-porous closed-cell foam material that is rigid in structure and is impermeable to water (e.g., has a water permeability of zero). While it is generally chemically resistant, cellular glass is known to degrade over time when exposed to certain liquids (e.g., water) at elevated temperatures. The general inventive concepts are based, in part, on the surprising discovery that certain conventional cellular glass adhesives/sealants do not sufficiently protect the surface of a cellular glass insulation block when submerged in such liquids. Further, Applicants have found that certain silicone-based coatings can provide enhanced sealing to allow the use of cellular glass insulation in submerged applications, such as in liquids at elevated temperatures.

While the general inventive concepts are applicable to a variety of insulation systems, the cellular glass for use according to the general inventive concepts is characterized by a stable thermal conductivity that does not substantially change when exposed to extreme environmental conditions. The cellular glass insulation is uniquely characterized within the insulation market since the product is formed using an insulating cell gas composition that cannot escape the glass structure. Those of ordinary skill in the art will recognize that different cellular glass densities and thickness will provide different properties and performance. Cellular glass insulation properties are categorized e.g., for the EU in EN 13167, which defines a variety of properties of cellular glass insulation. The general inventive concepts are related to increasing performance of the combination of cellular glass insulation and a sealant to prevent or mitigate drawbacks of conventional cellular glass-adhesive combinations.

In order to avoid undermining the mechanical/thermal characteristics of a cellular glass installation, the insulation system includes a sealant to effectively seal the cellular glass from the water in a liquid vessel/reservoir. Such a sealant (the terms “adhesive” and “sealant” as used herein, are intended to be interchangeable as the sealants according to the general inventive concepts provide both sealant and adhesive properties to the system) must provide a vapor/insulative barrier despite the extreme environmental conditions under which cellular glass systems are often used. Likewise, the sealant must demonstrate the ability to withstand the conditions over extended periods (e.g., up to and including 5 years) of exposure/submersion and heat.

Conventional insulation systems typically use an asphalt or gypsum-based sealant. While these sealants are suitable for a variety of conditions, they are not without drawbacks. Thus, there is a need for an effective replacement sealant that exhibits good sealant and insulative properties under harsh environmental conditions, that is compatible with cellular glass insulation, and that lacks the drawbacks of conventional sealants, even while submerged in heated water.

The general inventive concepts contemplate the use of a silicone sealant for use with a cellular glass insulation system. In certain exemplary embodiments, the silicone sealant is applied at a thickness of at least 0.5 mm, including thicknesses from 0.5 mm to 15 mm. In certain exemplary embodiments, the silicone sealant is applied at a thickness of 1 mm to 10 mm. In certain exemplary embodiments, the silicone sealant is applied at a thickness of 0.5 mm to 5 mm. In certain exemplary embodiments, the silicone sealant is applied at a thickness of 0.5 mm to 4 mm. In certain exemplary embodiments, the silicone sealant is applied at a thickness of 0.5 mm to 3 mm. In certain exemplary embodiments, the silicone sealant is applied at a thickness of 0.5 mm to 2.5 mm. In certain exemplary embodiments, the silicone sealant is applied at a thickness of 1 mm to 2 mm. In certain exemplary embodiment, the silicone sealant is applied at a rate of about 1 kg/m² to about 4 kg/m². In certain exemplary embodiment, the silicone sealant is applied at a rate of about 1.5 kg/m² to about 3.2 kg/m². In certain exemplary embodiment, the silicone sealant is applied at a rate of about 1.8 kg/m² to about 2.7 kg/m². In certain exemplary embodiment, the silicone sealant is applied at a rate of about 2 kg/m².

In any of the exemplary aspects of the general inventive concepts, the sealant is a silicone sealant, such as, for example a silicone rubber sealant. The silicone rubber sealant may comprise, for example, an alkoxy-cure silicone rubber sealant or an acetoxy-cure silicone rubber sealant. While not wishing to be bound by theory, Applicants believe performance is improved in sealants that include a lower amount of fillers or additives in the sealant. Thus, the general inventive concepts contemplate a sealant having a low level of fillers, i.e., less than 10%, including less than 7%, including less than 4%, including less than 2%, including less than 1% by weight, and including substantially no filler. In certain embodiments, the silicone sealant has a limited amount of additives, including having no fillers or only trace amounts of fillers in the sealant (i.e., the sealant is substantially free of fillers).

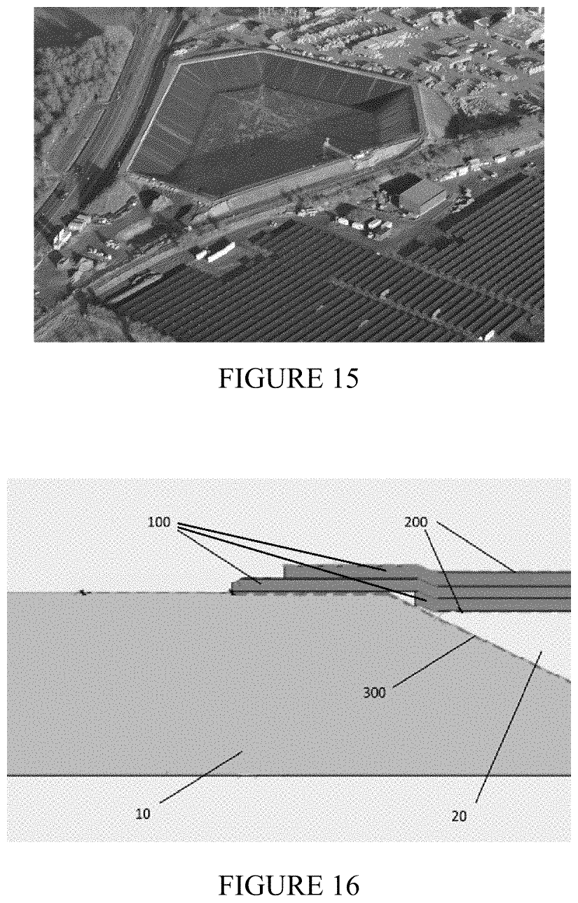

As mentioned, mechanical stability of an insulation system (including the adhesive) is an important property for submerged applications. As the insulation system is submerged, if there is an erosion of an insulation segment, the system will fail, requiring costly repair/replacement. This is especially true when the vessel or holding tank is relatively large. FIG. 15 shows an image of an exemplary water retention site where water is both heated and stored for extended periods of time. Accordingly, in certain exemplary embodiments, the general inventive concepts relate to a large tank or vessel, wherein a layer of cellular glass segments are provided on a portion of the surface of the vessel, including wherein the cellular glass segments define the exterior of the vessel. The segments include a silicone sealant according to the general inventive concepts on a liquid-facing side of the segment. In certain exemplary embodiments, each surface of the segment is coated with a silicone sealant.

The cellular glass insulation segments may be positioned in one or more layers directly on the liquid in the containment vessel. In certain embodiments, a first layer of coated cellular glass insulation segments is positioned on the liquid and at least one additional layer of cellular glass insulation segments is positioned above the first layer of coated cellular glass insulation segments. In certain embodiments, at least one layer of coated cellular glass insulation segments is buoyant and partially or completely submerged beneath the surface of the liquid. In certain embodiments, only a portion of one or more of the layers may be submerged beneath the surface of the liquid (i.e., certain insulation segments in a layer are submerged, while others are not).

By using a silicone sealant with improved sealing, protection of the foam glass block can be achieved even when the block is completely submerged in water for extended periods of time at an elevated temperature. The improved sealant/sealing also provides a strong mechanical bond between the adjacent segments of sealed cellular glass insulation, which further enhances the ability of the storage vessel to thermally insulate the heated liquid.

As previously mentioned, the general inventive concepts contemplate systems and methods of insulating a liquid within a liquid containment reservoir with cellular glass insulation, wherein some or all of the cellular glass insulation may be exposed to, or submerged in, heated water. Consequently, segments of the cellular glass insulation have a sealant applied to at least a portion of a liquid facing surface of the segments. In certain exemplary embodiments, the silicone sealant is applied to the entire liquid-facing surface of the cellular glass insulation segments. In certain exemplary embodiments, the silicone sealant is applied to more than one surface of the cellular glass insulation segments. In certain exemplary embodiments, the silicone sealant is applied to the entire surface of at least one of the cellular glass insulation segments. In certain exemplary embodiments, the silicone sealant is selected from an alkoxy-cure silicone rubber and an acetoxy-cure silicone rubber. In certain exemplary embodiments, the silicone sealant according to the general inventive concepts includes a low level of filler (i.e., less than 10%, including less than 7%, including less than 4%, including less than 2%, including less than 1% by weight, and including substantially no filler). In certain exemplary embodiments, the silicone sealant is an acetoxy-cure silicone rubber. In certain exemplary embodiments, the silicone sealant has a tensile strength of greater than 4 N/mm², including greater than 5 N/mm², including greater than 6 N/mm², including 6.5 N/mm² or more.

The general inventive concepts further contemplate a method of insulating a liquid within a liquid-containment vessel. The method comprises providing a plurality of cellular glass insulation segment and a silicone sealant according to the general inventive concepts. The method further comprises applying the silicone sealant to at least a portion of a liquid-facing surface of the cellular glass insulation segments and positioning the cellular glass insulation segments in a liquid storage vessel. In certain exemplary embodiments, the liquid is water and is heated to a temperature of at least 60° C., including a temperature of at least 90° C. In certain embodiments, at least one of the cellular glass insulation segments is submerged in the water. In certain embodiments, more than one surface of the cellular glass insulation segments is coated with the sealant, including the entire exterior of the cellular glass insulation segments. The sealant may be applied to the surface of the cellular glass by any means known in the art, such as brushing, spraying, dipping, curtain coating, and combinations thereof. In certain exemplary embodiments, the coated cellular glass segments comprise and/or define at least one exterior surface of the storage vessel, including the entire exterior of the vessel to insulate the heated liquid therein.

### EXAMPLES

The following examples illustrate features and/or advantages of the systems and methods according to the general inventive concepts. The examples are given solely for the purpose of illustration and are not to be construed as limitations of the general inventive concepts, as many variations thereof are possible without departing from the spirit and scope of the general inventive concepts.

### Example 1

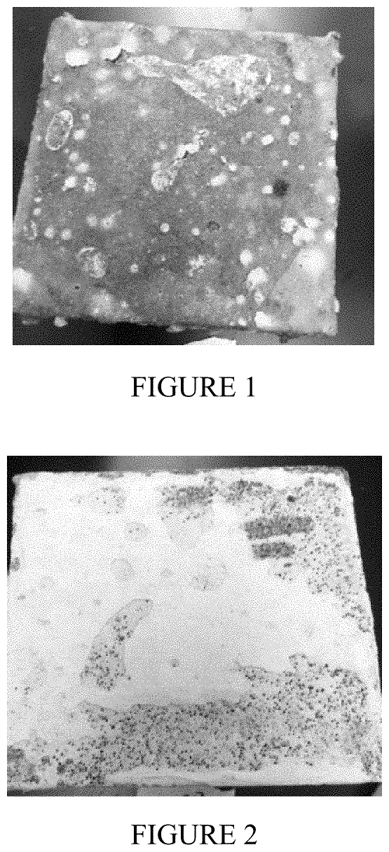

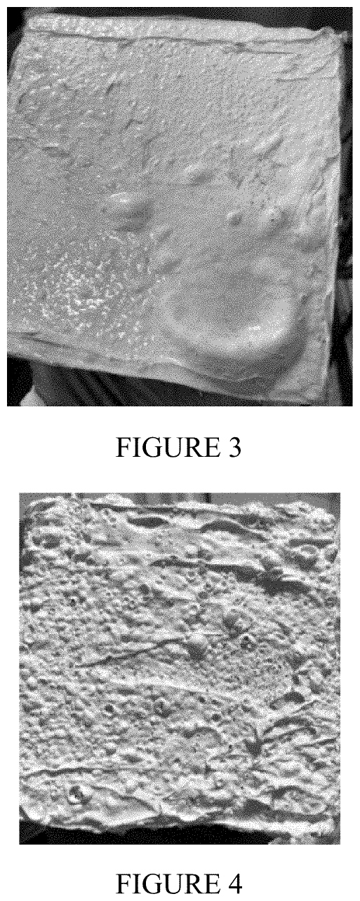

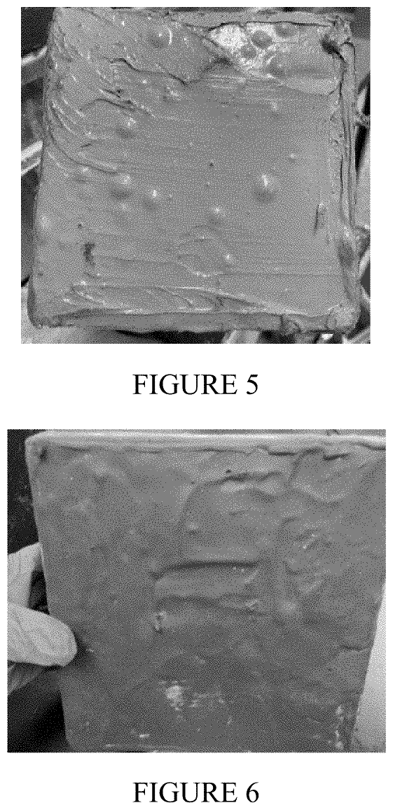

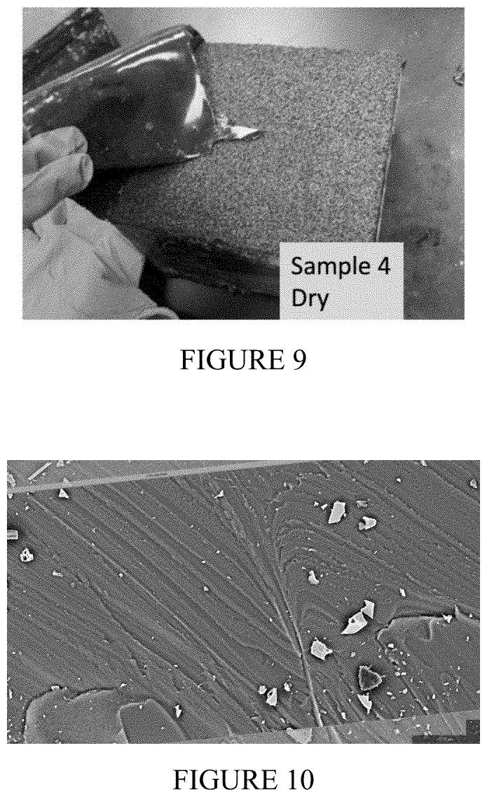

Foam glass sections were individually coated with approximately 2 mm of a series of 13 materials including a modified gypsum cement, a hot melt adhesive, hybrid polymer, polyurethane, and several silicone coatings. After curing of the sealant, the blocks were submerged in water at 90° C. for 25-32 days. FIGS. 1-9 show images of several exemplary foam glass blocks after submersion in heated water. After immersion testing, most of the coating materials failed due to the severe conditions. The typical failure mechanisms were surface erosion (e.g., gypsum with wax), bubbling (most polymeric coating materials), and softening and then breaking of the coating material (e.g., the hot melt adhesives). Water permeability was determined quantitatively. If a sample was found to be wet to the touch, this indicated water intrusion.

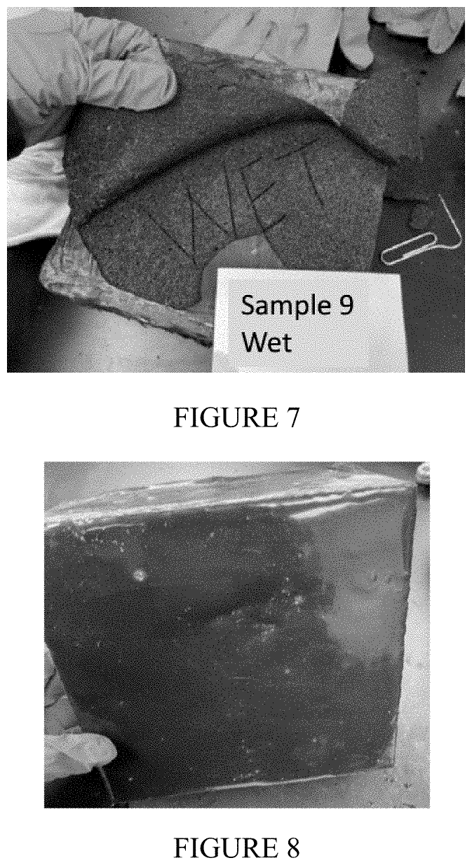

Applicants identified one silicone sealant material (FIG. 8) that not only showed intact surface features after 3-4 weeks of testing but also proved to be non-water permeable. Two other silicone materials (FIGS. 6 and 7) also showed intact surface features after testing, but after peeling off from the cellular glass its surface was found to be moist, meaning these two silicone materials allowed water to permeate into contact with the cellular glass surface. The silicone sealants that showed intact surfaces but were found to have allowed water to penetrate have a tensile strength according to ISO37 of less than 3, including about 2-2.5. The silicone sealant determined to be non-water-permeable after testing is an acetoxy-cure silicone rubber sealant with a tensile strength of greater than 6 according to ISO37 type 1.

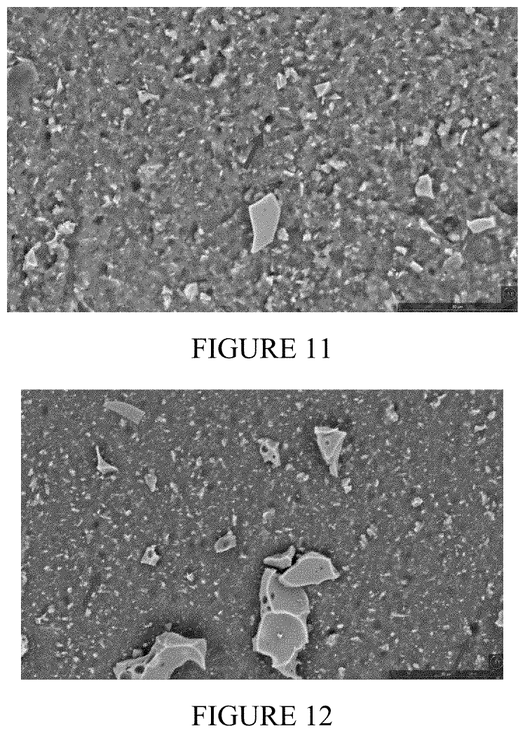

FIG. 10 shows an SEM image of a silicone sealant according to the general inventive concepts (i.e., those using an alkoxy cure and/or a tensile strength above 3-4). The SEM shows a relatively smooth surface with no substantial observable voids and a lack of filler particles. In contrast, FIGS. 11 and 12 show the silicone sealants that were observed to be intact after water immersion but were found to have allowed water intrusion. These images show large filler particle and voids in the sealant material (highlighted by arrows). Energy dispersive x-ray spectroscopy was performed on the materials in FIGS. 11 and 12 and it was determined that images indeed showed filler materials comprised of aluminum, oxygen, calcium, and carbon, among others. While not wishing to be bound by theory, Applicant believes the filler materials and/or voids may contribute to water infiltration and to a decrease in bond strength.

### Example 2

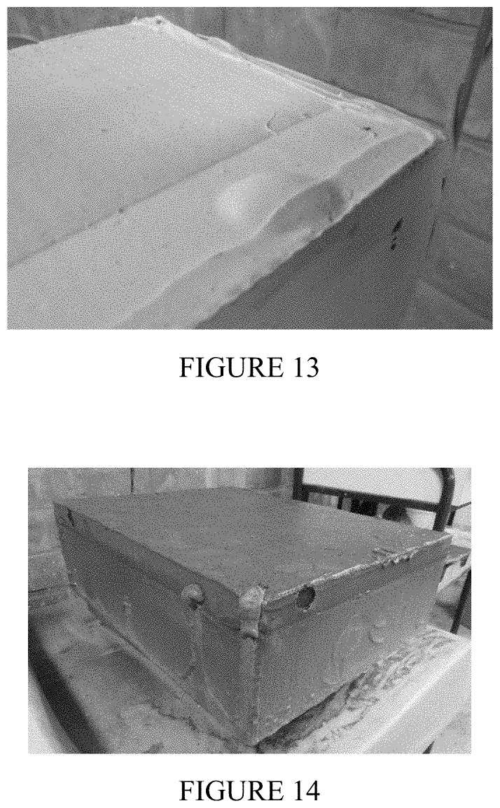

A slab of FOAMGLAS® was coated with a 2 mm layer of PC 62 (a solvent-free polyurethane adhesive coating often used to seal cellular glass pipe segments). A glass fabric (PC 150) was also used to reinforce a major side of the cellular glass that will be in contact with the water. The coating was applied to achieve an average coat weight of about 2 kg/m′ (FIG. 13). The coated slab was allowed to cure for one week and was then placed in a water bath. The bath was heated from ambient to 90° C.+. In order to limit evaporation, a lid is placed on top of the bath. Every 7 days the bath temperature is reduced and the sample weighed and assessed. After 3 weeks, the sample was in good condition with no discoloration or blistering. After one month, two blisters had formed. After 7 weeks, the sample showed substantial discoloration and additional blistering. After 2 months, the sample had increased in weight (indicating water intrusion), was tacky to the touch, and begun to disintegrate. The sample also showed signs of increased discoloration (FIG. 14). Testing was discontinued at this time.

FIG. 15 shows an image of a large, insulated liquid containment vessel (e.g., a water tank) according to the general inventive concepts. FIG. 16 is a drawing showing an exemplary system for insulating a liquid containment vessel (e.g., a heated water tank) according to the general inventive concepts. Ground material (e.g., soil, backfill, gravel, etc.) 10, makes up a side of the vessel, though those of ordinary skill will understand that other materials may provide the external support structure depending on the shape and size of the vessel/tank. Water or other heated liquid 20, occupies the interior of the liquid containment vessel. In this embodiment, three layers of cellular glass 100 with a silicone sealant provides a layer of insulation to the liquid containment vessel. Membranes (e.g., HDPE geomembranes or other suitable material) 200 may also be included on one of more surfaces of the cellular glass layer to provide additional protection to the vessel and/or provide additional thermal insulation or protection from wear.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

The cellular glass compositions, and corresponding methods of the present disclosure can comprise, consist of, or consist essentially of the essential elements and limitations of the disclosure as described herein, as well as any additional or optional ingredients, components, or limitations described herein or otherwise useful in foam glass composition applications.

The cellular glass compositions of the present disclosure may also be substantially free of any optional or selected ingredient or feature described herein, provided that the remaining composition still contains all of the required elements or features as described herein. In this context, and unless otherwise specified, the term “substantially free” means that the selected composition contains less than a functional amount of the optional ingredient, typically less than 0.1% by weight, and also including zero percent by weight of such optional or selected essential ingredient.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the Applicant intends to indicate “only A or B but not both,” then the term “only A or B but not both” will be employed. Thus, use of the term “or” herein is the inclusive, and not the exclusive use. In the present disclosure, the words “a” or “an” are to be taken to include both the singular and the plural. Conversely, any reference to plural items shall, where appropriate, include the singular.

In some aspects, it may be possible to utilize the various inventive concepts in combination with one another. Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

While the invention has been illustrated and described in detail in the drawings and foregoing description, the same is to be considered as illustrative and not restrictive in character. It should be understood that only the exemplary embodiments have been shown and described and that all changes and modifications that come within the spirit of the invention are desired to be protected.

1. A cellular glass insulation system for insulating a liquid containment vessel comprising a liquid at an elevated temperature, the system comprising:
a plurality of cellular glass insulation segments, wherein each of the cellular glass insulation segments comprises a liquid facing surface, a surface opposing the liquid facing surface, and a plurality of side surfaces extending between the liquid facing surface and inner surface; and
a silicone sealant applied on at least a portion of the liquid-facing surface of the cellular glass insulation segments.

2. The cellular glass insulation system of claim 1, wherein the silicone sealant is applied to more than one surface of the cellular glass insulation segments.

3. The cellular glass insulation system of claim 1, wherein the silicone sealant is selected from an alkoxy-cure silicone rubber and an acetoxy-cure silicone rubber.

4. The cellular glass insulation system of claim 1, wherein the silicone sealant is an acetoxy-cure silicone rubber.

5. The cellular glass insulation system of claim 1, wherein the silicone sealant is applied at a thickness of from 0.5 mm to 5 mm.

6. The cellular glass insulation system of claim 1, wherein the silicone sealant covers each surface of the cellular glass insulation segments.

7. The cellular glass insulation system of claim 1, wherein the silicone sealant is applied at a rate of about 1 kg/m′ to about 4 kg/m′.

8. A method of insulating a liquid containment vessel comprising a liquid at an elevated temperature, the method comprising:
applying a silicone sealant to at least a portion of a liquid-facing surface of a plurality of cellular glass insulation segments;
positioning the cellular glass insulation segments in a liquid containment vessel; and
adhering the cellular glass insulation segments to one another.

9. The method of claim 8, wherein the liquid is water.

10. The method of claim 8, wherein the liquid is heated to a temperature of at least 60° C.

11. The method of claim 10, wherein the liquid is heated to a temperature of at least 90° C.

12. The method of claim 8, wherein the cellular glass insulation segments are positioned on the liquid.

13. The method of claim 12, wherein the cellular glass insulation segments are positioned in at least one layer on the liquid.

14. The method of claim 13, wherein at least one cellular glass insulation segment is at least partially submerged in the liquid.

15. The method of claim 8, wherein the silicone sealant coats each surface of the cellular glass insulation segments.

16. The method of claim 8, wherein the silicone sealant is selected from an alkoxy-cure silicone rubber and an acetoxy-cure silicone rubber.

17. The method of claim 8, wherein the silicone sealant is an acetoxy-cure silicone rubber.

18. The method of claim 8, wherein the silicone sealant is applied at a thickness of from 0.5 mm to 5 mm.

19. The method of claim 8, wherein the silicone sealant is applied at a rate of about 1 kg/m² to about 4 kg/m².

20. The method of claim 8, wherein applying the sealant comprises one or more of brushing, spraying, dipping, and curtain coating.
